(19) United States
(12) Patent Application Publication
(10) Pub. No.: US 2025/0265019 A1
(43) Pub. Date: Aug. 21, 2025

(54) PERFORMING INTERNAL DATA RELOCATION READS IN MEMORY DEVICES

(71) Applicant: Micron Technologies, Inc., Boise, ID (US)

(72) Inventors: Sangeetha Shetty, Bengaluru (IN); Pranam Shetty, Bengaluru (IN); Arunkumar B, Bangalore (IN); Joshua Wyatt Hieb, Boise, ID (US); Xiangyu Tang, San Jose, CA (US); Sundararajan Sankaranarayanan, Fremont, CA (US)

(21) Appl. No.: 19/054,278

(22) Filed: Feb. 14, 2025

Related U.S. Application Data
(60) Provisional application No. 63/554,010, filed on Feb. 15, 2024.

(51) Int. Cl. G06F 3/06

(52) U.S. Cl. CPC G06F 3/0659; G06F 3/0613; G06F 3/0688

(57) ABSTRACT

A source block of a memory device for performing a media management operation is selected, wherein the source block comprises one or more translation units (TUs), and wherein a TU comprises a respective set of memory cells. One or more valid TUs in the source block are identified, wherein each valid TU of the one or more valid TUs corresponds to a respective set of memory cells comprising valid data. The one or more valid TUs identified in the source block are grouped into one or more candidate groups. The media management operation is performed by: executing one or more read operations to retrieve the valid data from the one or more candidate groups of TUs, and writing the valid data into one or more destination blocks.

### RELATED APPLICATIONS

This application claims the benefit of U.S. Provisional Patent Application No. 63/554,010, filed Feb. 15, 2024, entitled “Performing internal Data Relocation Reads in Memory Devices” which is incorporated by reference herein.

### TECHNICAL FIELD

Embodiments of the disclosure relate generally to memory sub-systems, and more specifically, relate to performing internal data relocation reads in memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a flow diagram of an example method of performing an internal data relocation read in accordance with some embodiments of the present disclosure.

FIG. 3A is a diagram illustrating an example implementation of an internal data relocation read involving valid TUs that are sequentially arranged, in accordance with some embodiments of the present disclosure.

FIG. 3B is a diagram illustrating an example implementation of an internal data relocation read involving valid TUs that are sequentially arranged, in accordance with some embodiments of the present disclosure.

FIG. 4A is a diagram illustrating an example implementation of an internal data relocation read involving valid TUs that are randomly arranged, in accordance with some embodiments of the present disclosure.

FIG. 4B is a diagram illustrating an example implementation of an internal data relocation read involving valid TUs that are randomly arranged, in accordance with some embodiments of the present disclosure.

FIG. 5 is a block diagram of an example computer system in which embodiments of the present disclosure may operate.

### DETAILED DESCRIPTION

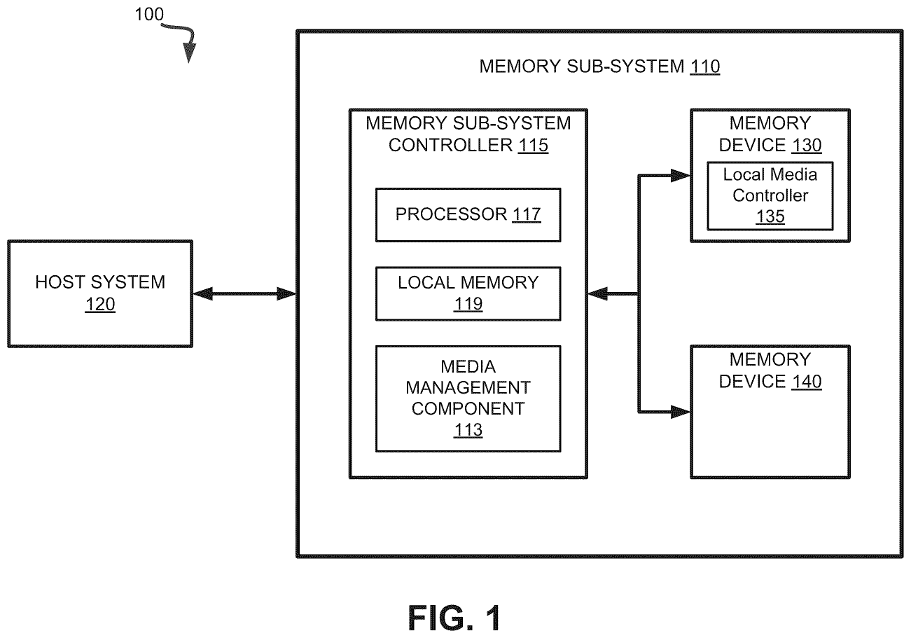

Aspects of the present disclosure are directed to a method of performing internal data relocation reads in memory devices. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of translation units (“TUs”). Each TU includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. The memory cells can be formed onto a silicon wafer in an array of columns and rows. A bitline can refer to one or more conductive lines coupled to a column of associated memory cells in a memory device. A wordline can refer to one or more conductive lines coupled to a row of associated memory cells in a memory device that are used with one or more bitlines to generate the address of each of the memory cells. The intersection of a bitline and a wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory TU accesses of two or more memory planes. For example, the memory device can include multiple access line driver circuits and power circuits that can be shared by the planes of the memory device to facilitate concurrent access of TUs of two or more memory planes, including different TU types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device. For example, a multi-plane read operation may be executed along a multi-plane wordline (i.e., a wordline spanning across multiple planes).

One example of a memory sub-system is a solid-state drive (SSD) that includes one or more non-volatile memory devices and a memory sub-system controller to manage the non-volatile memory devices. A memory device in a memory sub-system can include multiple memory cells arranged into multiple TUs storing one or more bits of binary data corresponding to data received from the host system. A TU is the minimum set of memory cells (e.g., a page) that can be addressed by a memory device or component thereof. A single plane wordline (i.e., a wordline spanning across a single plane) may consist of one or more TUs.

In SSDs, data is typically written at the TU level, meaning that an entire TU, or multiple TUs, may be written to in a single operation. When the memory device reaches its full capacity, leaving no room for additional write operations, some data must be erased to create space. However, SSD architecture, such as in NAND devices, may not allow for data to be directly overwritten. Therefore, when data needs to be updated or modified, the new version of that data is written to a new TU, and the previously used TU is marked as invalid. An invalid TU is a set of memory cells comprising data that is no longer needed. This data may be no longer needed because a newer version has been stored on the memory device or because the data no longer serves a purpose. In contrast, a valid TU is a set of memory cells comprising valid data, where valid data is the most recent version of such data stored on the memory device.

Thus, when a segment of data on the memory device is updated, some TUs within a block become invalid. The host would overwrite a certain amount of data as it fills the SSD, which would invalidate previously written data, leading to written blocks having fewer valid data. Over time, this may result in blocks that are partially filled with valid TUs, an inefficient use of the storage space that may detrimentally impact SSD performance, including host write operations. In addition, the entire block cannot simply be erased as it likely contains some number of TUs containing valid data.

Garbage Collection (GC) is a process of re-organizing data and freeing up unused space for new writes. A GC process may involve, for a chosen block, moving the TUs that contain valid data to another block, so that the chosen block can be erased and rewritten. The GC process may be performed using a media management operation such as folding.

Folding, which refers to a media management operation in GC, involves reading valid data from a written block (referred to as a “source block”) through one or more read operations and writing the read data to a destination (e.g., available) block. This process is aimed at packing the valid data together and freeing up space for new writes, error avoidance, error recovery, or wear leveling.

As part of the media management operation, multiple read operations may be performed on the valid data in the source block. However, in certain SSDs, each die is limited to one outstanding read operation at a time, meaning a die engaged in a read operation cannot simultaneously perform another read operation within the same die.

The single outstanding read per die limitation may not be an issue if the valid TUs are sequential, spanning over the entire multi-plane wordline of the die. An SSD may support multi-plane read operations when using certain architectures (e.g., NAND). This process leverages parallelism by enabling multiple read commands to be executed simultaneously across different planes. Specifically, it involves issuing separate read commands to each plane to TUs along the same wordline. While each plane conducts its read operation independently, these occur concurrently, enhancing throughput and efficiency. Such a parallel approach significantly accelerates data access, allowing for the simultaneous retrieval of multiple data pieces from various planes.

However, when random valid TUs are spread across different wordlines and planes of a die, the number of necessary read iterations, each consisting of read operations on one or more planes, increases. While a multi-plane read may only read across multiple planes of a die along the same wordline, the limitation of one outstanding read per die necessitates multiple read iterations. This increases the time needed to complete the folding read phase for the block, slowing the overall garbage collection process and affecting SSD performance, including host write performance. The more scattered the data, the higher the latency in data access due to increased read iterations. This method of issuing multiple non-concurrent read operations for non-contiguous data incurs additional overhead; each operation requires its own read iteration of command processing and execution, adversely affecting host write performance in mixed (e.g., sequential and random arrangements of valid TUs) or random arrangement-dominant workloads.

Aspects of the present disclosure address the above and other deficiencies by optimizing internal data relocation reads. In an embodiment, the memory controller selects a source block of memory for a media management operation. In some embodiments, this selection may be based on the amount of valid data stored in a block and whether that amount falls below an acceptable or set threshold. This data is represented in the source block as valid and invalid TUs (e.g., pages). The memory controller identifies any valid TUs stored in the source block, each valid TU corresponding to a respective set of memory cells that contain valid data. In some embodiments, these valid TUs may be identified using a physical-to-logical (P2L) table.

The memory controller may group these identified valid TUs into one or more candidate groups for optimized reading (e.g., for internal data relocation). Depending on the circumstances, the method of organizing the identified valid TUs may vary. For example, in some embodiments, where every TU on a multi-plane wordline of a die is valid, all TUs corresponding to that multi-plane wordline may be associated with a single “multi-plane read candidate group.” In some embodiments, where there are multi-plane wordlines with at least one invalid TU, the valid TUs corresponding to these multi-plane wordlines may be collectively grouped into a number of “independent wordline (IWL) read candidate groups.” IWL read candidate groups may be used when multiple valid TUs are randomly spread across different wordlines and planes of a die. In some embodiments, the one or more candidate groups that have been generated may be enqueued into a read iteration queue, from which one or more read operations may be executed.

The memory controller performs the media management operation, which can include executing read operations on the candidate groups of valid TUs to retrieve the valid data from the TUs, as well as writing the valid data retrieved from the read operations into an available “destination block.” In some embodiments, this media management operation may constitute a folding operation.

Advantages of the present disclosure include improving overall host write performance. In particular, the described approach optimizes internal data relocation reads, mitigating the unnecessary overhead that typically plagues GC operations, especially in GC operations with mixed (e.g., sequential and random arrangement of valid TUs) or random arrangement-dominant workloads.

Methods of the present disclosure group the valid data into one or more candidate groups, allowing for a more efficient and effective approach to handling each data arrangement, enabling concurrent reads with enhanced efficiency even when valid TUs are not sequentially arranged along a multi-plane wordline. These methods allow faster and more efficient internal data reads, increasing the pace of GC operations and thereby allowing for more host writes to be accepted—improving host write performance even in situations with non-sequential valid TUs.

Building upon this foundation, optimizing internal data relocation reads such that they may provide concurrent execution of read commands across different planes, regardless of the arrangement of valid data, significantly enhances system performance, especially given the typical limitation of one outstanding read per die in such devices.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not- and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as translation units (TUs) that can refer to a logical unit of the memory device used to store data. With some types of memory (e.g., NAND), TUs can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)—MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a media management component 113 that can perform internal data relocation reads on the blocks of the memory devices 130, 140. In some embodiments, the memory sub-system controller 115 includes at least a portion of the media management component 113. In some embodiments, the media management component 113 is part of the host system 120, an application, or an operating system. In other embodiments, local media controller 135 includes at least a portion of media management component 113 and is configured to perform the functionality described herein.

In an embodiment, the media management component 113 selects a block of memory for a media management operation from the memory devices 130, 140. A selected block is referred to as a “source block.” The media management component 113 identifies any valid TUs stored on the source block, each corresponding to a specific set of memory cells that contain valid data. The media management component 113 groups these identified valid TUs into one or more candidate groups for optimized internal data reading. Depending on the circumstances, the method of grouping the identified valid TUs may vary. In some examples, where every TU on a multi-plane wordline of a die is valid, all TUs corresponding to that wordline may be associated with a single “multi-plane read candidate group.” In some examples, where there are multi-plane wordlines with at least one invalid TU, the valid TUs corresponding to these multi-plane wordlines may be collectively grouped into one or more “IWL read candidate groups.” The media management component 113 performs the media management operation, which can include executing read operations on the candidate groups of valid TUs to retrieve the valid data from the TUs, as well as writing the valid data retrieved from the read operations into an available “destination block.” Further details with regards to the operations of the media management component 113 are described below.

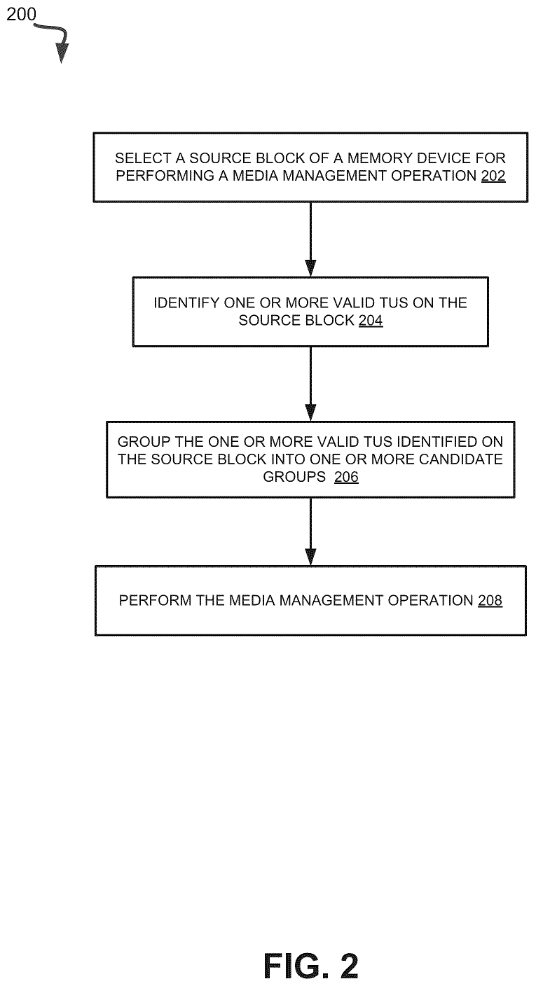

FIG. 2 is a flow diagram of an example method 200 of performing an internal data relocation read in a memory sub-system in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the media management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 202, the processing logic (e.g., media management component 113) selects a source block of a memory device for performing a media management operation. This source block includes one or more TUs, with each TU being a collection of memory cells.

In some embodiments, selecting the source block (at operation 202) for performing the media management operation is performed responsive to the source block meeting a threshold criterion, and wherein the threshold criterion comprises a threshold number of valid data items in the source block.

In selecting a source block, the processing logic may scan one or more blocks in the memory device to determine if the amount of valid data items in any block of the memory device falls below a certain threshold such that it may affect performance and warrants the media management operation. If a block meets the threshold criterion (e.g., valid data comprised in the block is less than a specific percentage of the block capacity), the block will be selected as a source block.

At operation 204, the processing logic identifies one or more valid TUs on the source block, wherein each valid TU of the one or more valid TUs corresponds to a respective set of memory cells comprising valid data.

In some embodiments, the one or more valid TUs may be identified in the source block using a physical-to-logical (P2L) table. A P2L table may be used to determine if the TU of the one or more TUs in the source block is a valid TU of the one or more valid TUs in the source block.

The memory sub-system may maintain a P2L table to identify the physical location (e.g., physical address) where the data corresponding to each logical address resides. The P2L table can include a number of P2L entries. Each entry in a P2L table may identify a logical address of a TU identified by its physical location. In some embodiments, the P2L table may be indexed by the physical addresses. Each P2L entry can include a physical address, a corresponding logical address, and some other optional metadata. If the physical address contains invalid data (e.g., data that has a newer version stored on the memory device, etc.) a reserved value (e.g., all “1”'s in the binary representation) is utilized as the logical address. In a P2L table, TUs corresponding to invalid data can be identified by selecting P2L entries with the reserved value in the logical address field.

In addition, a flag can be maintained as metadata in a P2L entry to identify a TU as valid or invalid; a flag can be used to indicate the TU corresponding to a P2L entry has valid data. In one example, a P2L entry can include a physical address of the physical location corresponding to a particular TU and each physical address in a P2L entry can have a corresponding flag. If there is valid data at a physical address, a flag corresponding to the physical address in the P2L entry can be set to indicate that there is valid data. Similarly, if there is invalid data at a physical address, a flag corresponding to the physical address in the P2L entry can be set to indicate that there is invalid data.

When the host system requests to access data (e.g., read data), the host system can send a data access request to the memory device that is directed to the logical address space. For example, the host system can provide a logical address (e.g., an LBA, etc.) to the memory sub-system controller 115. Using the LBA, memory sub-system controller 115 can identify the physical location where the data is to be stored at or read from.

At operation 206, the processing logic groups the one or more valid TUs identified on the source block into one or more candidate groups. Depending on the circumstances, the method of organizing the identified valid TUs may vary.

For example, in some embodiments, all TUs corresponding to a multi-plane wordline may be collectively grouped into a “multi-plane read candidate group.”

The processing logic identifies one or more multi-plane read candidates, each a valid TU from the identified source block. These multi-plane read candidates correspond to a multi-plane wordline in which all corresponding TUs are valid TUs. The processing logic then groups these multi-plane read candidates into a “multi-plane read candidate group,” where each TU in a candidate group is associated with the same multi-plane wordline.

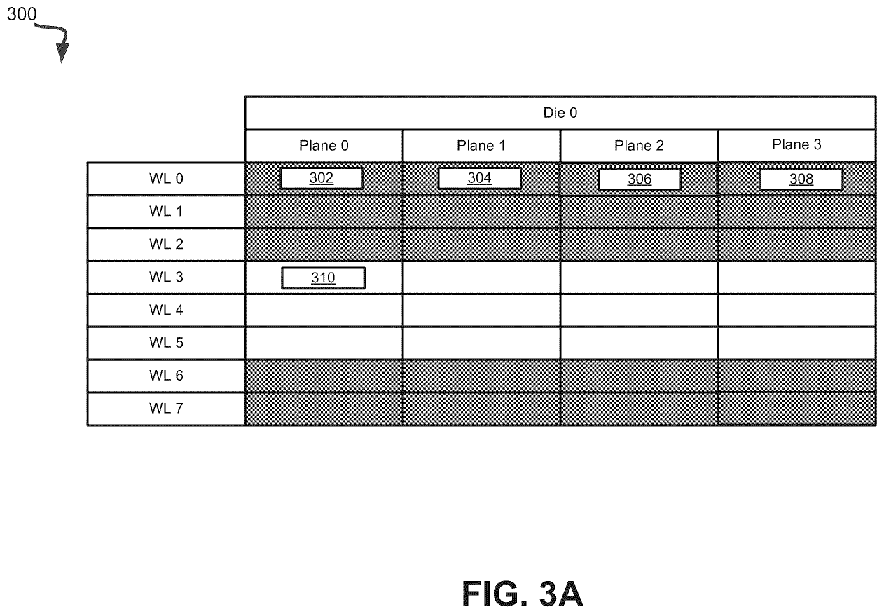

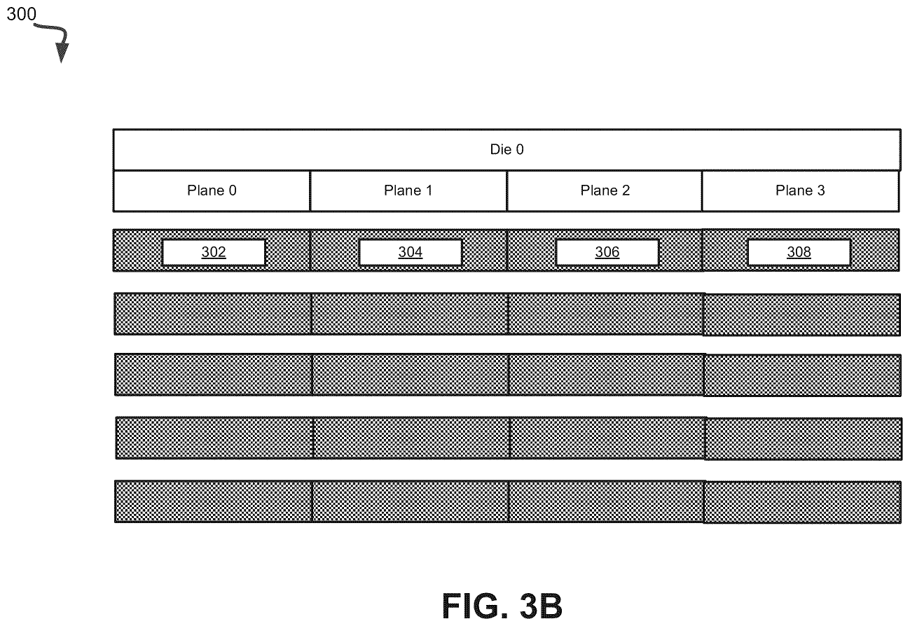

FIG. 3A is a diagram illustrating an example implementation 300 of an internal data relocation read involving valid TUs that are sequentially arranged, in accordance with some embodiments of the present disclosure.

Depicted in this example implementation 300 is a diagram organized to illustrate the example implementation. In this example, within a Die 0 are four different planes, Plane 0, Plane 1, Plane 2, and Plane 3. Within each plane is a number of TUs (which may be components of one or more blocks of each plane), each represented by a rectangular box, spanning multi-plane wordlines, WL 0 through 7. A shaded box, such as TU 302, represents a valid TU comprising valid data. An unshaded box, such as TU 310, represents an invalid TU comprising invalid data.

In this example implementation 300, each of the valid TUs that had been identified at operation 204 are shown to be located along a multi-plane wordline in which there are only valid TUs. As such, in accordance with some embodiments of the present disclosure, each of the valid TUs across the multi-plane wordline may be placed into a multi-plane read candidate group. For example, TUs 302, 304, 306, and 308 may be grouped into a candidate group corresponding to wordline (WL) 0. The valid TUs along WL 1, WL 2, WL 6, and WL 7 may also be placed into multi-plane read candidate groups, each group containing valid TUs corresponding to their respective multi-plane wordline. FIG. 3B illustrates a “grouped” multi-plane read candidate group contained within a read iteration queue, in accordance with some embodiments of the present disclosure. TUs 302, 304, 306, and 308, each located in a different plane, may be grouped into a multi-plane read candidate group.

Referring again to FIG. 2, in some embodiments, where there are wordlines with at least one invalid TU, the valid TUs corresponding to these multi-plane wordlines may be collectively grouped into one or more “IWL read candidate groups.” This is typically when there are multiple valid TUs randomly spread across different wordlines and planes of a die.

Identified as “IWL read candidates,” these valid TUs, located on multi-plane wordlines with at least one invalid TU, are accessible through the use of IWL read commands. Unlike with a multi-plane read command, IWL read commands allow for concurrent reads to access multiple TUs in different (i.e., “independent”) wordlines and in different planes. These commands enable efficient multi-plane reading of randomly arranged valid TUs, allowing for fewer iterations across various wordlines within a busy die, similar to the parallelism employed by multi-plane reads in SSDs.

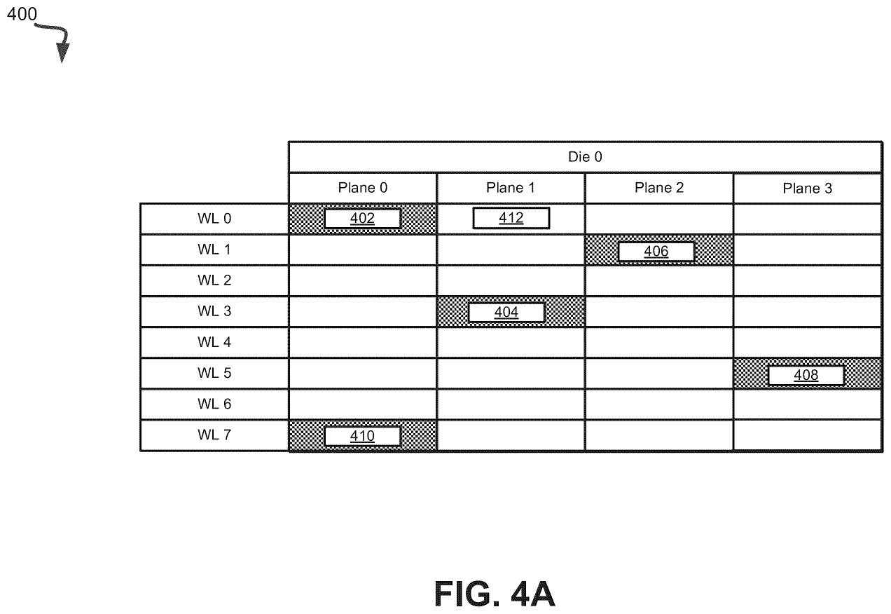

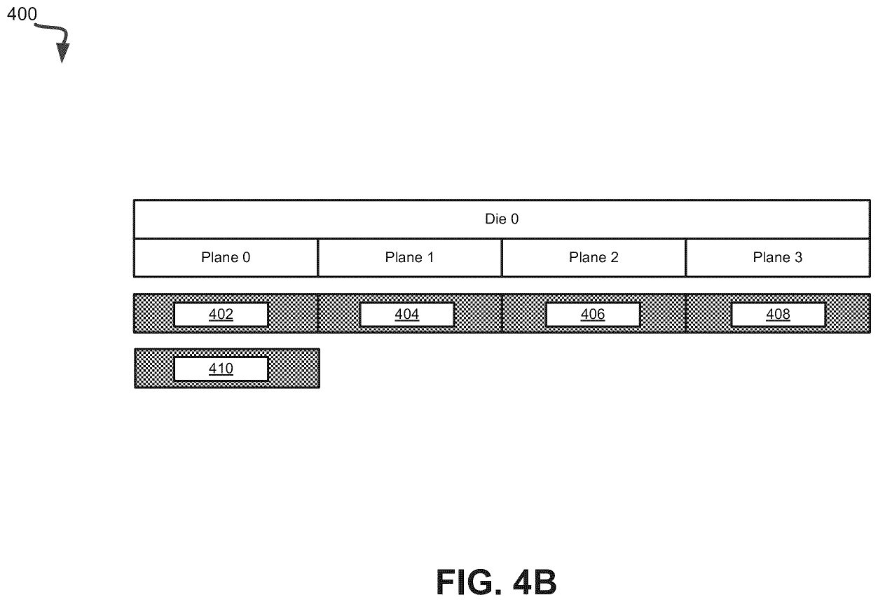

FIG. 4A is a diagram illustrating an example implementation 400 of an internal data relocation read involving valid TUs that are randomly arranged, in accordance with some embodiments of the present disclosure.

Depicted in this example implementation 400 is a diagram organized to illustrate the example implementation. In this example, within a Die 0 are four different planes, Plane 0, Plane 1, Plane 2, and Plane 3. Within each plane is a number of TUs, each represented by a rectangular box, spanning multi-plane wordlines, WL 0 through 7. A shaded box, such as TU 402, represents a valid TU comprising valid data. An unshaded box, such as TU 412, represents an invalid TU comprising invalid data.

In this example implementation 400, each of the valid TUs that had been identified at operation 204 are shown to be located along multi-plane wordlines in which there is at least one invalid TU. For example, in WL 0, TU 402 (a valid TU) is in the same multi-plane wordline as TU 412 (an invalid TU). Since a typical multi-plane read is only along a single multi-plane wordline and a die is limited to one outstanding read operation, this would mean that the TUs 402, 404, 406, 408, and 410 would not be able to be read concurrently. In this example, completing a read of the valid TUs of the die would require five read iterations, each read iteration corresponding to WL 0, WL 1, WL 3, WL 5, and WL 7 for TUs 402, 406, 404, 408, and 410, respectively.

However, in accordance with some embodiments of the present disclosure, each of the valid TUs across each wordline may be placed into an IWL read candidate group. One valid TU may be taken from each plane. FIG. 4B illustrates a “grouped” IWL read candidate group contained within a read iteration queue, in accordance with some embodiments of the present disclosure. TUs 402, 404, 406, and 408, each located in a different plane, may be grouped into a first IWL read candidate group, while TU 410 might be grouped into a second IWL read candidate group.

In some embodiments, the size of the IWL read operation for a multi-plane wordline varies depending on the number and arrangement of valid TUs across a multi-plane wordline of a die. For example, in a multi-plane wordline in which only one TU is a valid TU, an IWL read operation sized to read a single TU may be executed. This size may vary depending on the size of a single TU. In another example, in a multi-plane wordline in which there are two TUs that are valid and are sequentially arranged, an IWL read operation sized to read two sequentially arranged TUs may be executed. If the two TUs in this example are not sequentially arranged, a different IWL read operation size may be executed. In a further example, in a multi-plane wordline in which there are three or more TUs that are valid and are sequentially arranged, a certain size of IWL read operation may be executed.

Referring again to FIG. 2, at operation 208, the processing logic performs the media management operation by: executing one or more read operations to retrieve the valid data from the one or more candidate groups of TUs, and writing the valid data into one or more destination blocks.

In executing one or more read operations on the one or more candidate groups of TUs, specifically, the processing logic issues individual read commands to the TUs in each candidate group on each plane. For example, in FIG. 4B, individual IWL read commands would be issued for each valid TU in the IWL read candidate group consisting of TUs 402, 404, 406, and 408. As mentioned, IWL read commands facilitate concurrent reads of multiple TUs on different wordlines in various planes, suitable for scenarios with valid TUs randomly dispersed. The read commands for this candidate group may be executed concurrently within a read iteration.

In some embodiments, the one or more candidate groups that have been generated may be enqueued into a read iteration queue, from which the one or more read operations conducted on the one or more candidate groups at operation 208 may be executed. Depending on the circumstances, the read iteration queue may contain various candidate groups; each candidate group in the read iteration queue may utilize a different method of organizing the identified valid TUs (i.e., the read iteration queue may comprise different types of candidate groups). Once read operations are conducted on a candidate group, the read iteration queue may iterate to the next candidate group for further read operations. In some embodiments, candidate groups using a certain method of organizing the identified valid TUs may be prioritized, affecting the order in which the candidate groups are read.

In some embodiments, the media management operation comprises a folding operation, the folding operation comprising transferring the valid data retrieved from the one or more read operations into one or more destination blocks.

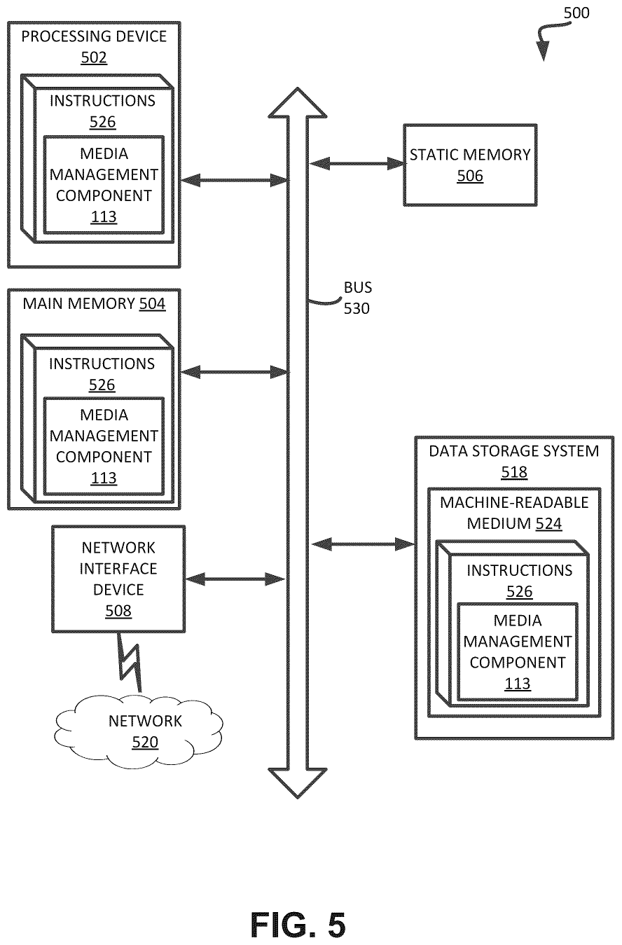

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a media management component (e.g., the media management component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (ROM), random access memory (RAM), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a plurality of memory devices; and
a processing device, operatively coupled with the plurality of memory devices, to perform operations comprising:
selecting, by a processing device, a source block of a memory device for performing a media management operation, wherein the source block comprises one or more translation units (TUs), and wherein a TU comprises a respective set of memory cells;
identifying one or more valid TUs in the source block, wherein each valid TU of the one or more valid TUs corresponds to a respective set of memory cells comprising valid data;
grouping the one or more valid TUs identified in the source block into one or more candidate groups; and
performing the media management operation by: executing one or more read operations to retrieve the valid data from the one or more candidate groups of TUs, and writing the valid data into one or more destination blocks.

2. The system of claim 1, wherein grouping the one or more valid TUs identified on the source block into one or more candidate groups further comprises:
enqueuing the one or more candidate groups into a read iteration queue, from which the one or more read operations on the one or more candidate groups of TUs are executed.

3. The system of claim 1, wherein grouping the one or more valid TUs identified on the source block into one or more candidate groups further comprises:
identifying one or more multi-plane read candidates, wherein each of the one or more multi-plane read candidates is a valid TU of the one or more valid TUs identified on the source block, each of the one or more multi-plane read candidates corresponding to a respective multi-plane wordline, wherein all the one or more TUs are valid TUs; and
populating a multi-plane read candidate group with the one or more multi-plane read candidates, each of the one or more multi-plane read candidates corresponding to the respective multi-plane wordline.

4. The system of claim 1, wherein grouping the one or more valid TUs identified on the source block into one or more candidate groups further comprises:
identifying one or more independent wordline (IWL) read candidates, wherein each of the one or more IWL read candidates is a valid TU of the one or more valid TUs identified on the source block, each corresponding to a multi-plane wordline, wherein at least one TU corresponding to the multi-plane wordline is an invalid TU, and wherein an invalid TU is a TU corresponding to a set of memory cells comprising invalid data; and
populating an IWL read candidate group with an IWL read candidate, of the one or more IWL read candidates, corresponding to each plane in a die.

5. The system of claim 1, wherein selecting the source block for performing the media management operation is performed responsive to the source block meeting a threshold criterion, and wherein the threshold criterion comprises a threshold number of valid data items in the source block.

6. The system of claim 1, wherein identifying the one or more valid TUs in the source block further comprises:
using a physical-to-logical (P2L) table to determine if the TU of the one or more TUs in the source block is a valid TU of the one or more valid TUs in the source block.

7. The system of claim 1, wherein the memory device comprises a NAND flash memory device.

8. A method comprising:
selecting, by a processing device, a source block of a memory device for performing a media management operation, wherein the source block comprises one or more translation units (TUs), and wherein a TU comprises a respective set of memory cells;
identifying one or more valid TUs in the source block, wherein each valid TU of the one or more valid TUs corresponds to a respective set of memory cells comprising valid data;
grouping the one or more valid TUs identified in the source block into one or more candidate groups; and
performing the media management operation by: executing one or more read operations to retrieve the valid data from the one or more candidate groups of TUs, and writing the valid data into one or more destination blocks.

9. The method of claim 8, wherein grouping the one or more valid TUs identified on the source block into one or more candidate groups further comprises:
enqueuing the one or more candidate groups into a read iteration queue, from which the one or more read operations on the one or more candidate groups of TUs are executed.

10. The method of claim 8, wherein grouping the one or more valid TUs identified on the source block into one or more candidate groups further comprises:
identifying one or more multi-plane read candidates, wherein each of the one or more multi-plane read candidates is a valid TU of the one or more valid TUs identified on the source block, each of the one or more multi-plane read candidates corresponding to a respective multi-plane wordline, wherein all the one or more TUs are valid TUs; and
populating a multi-plane read candidate group with the one or more multi-plane read candidates, each of the one or more multi-plane read candidates corresponding to the respective multi-plane wordline.

11. The method of claim 8, wherein grouping the one or more valid TUs identified on the source block into one or more candidate groups further comprises:
identifying one or more independent wordline (IWL) read candidates, wherein each of the one or more IWL read candidates is a valid TU of the one or more valid TUs identified on the source block, each corresponding to a multi-plane wordline, wherein at least one TU corresponding to the multi-plane wordline is an invalid TU, and wherein an invalid TU is a TU corresponding to a set of memory cells comprising invalid data; and
populating an IWL read candidate group with an IWL read candidate, of the one or more IWL read candidates, corresponding to each plane in a die.

12. The method of claim 8, wherein selecting the source block for performing the media management operation is performed responsive to the source block meeting a threshold criterion, and wherein the threshold criterion comprises a threshold number of valid data items in the source block.

13. The method of claim 8, wherein identifying the one or more valid TUs in the source block further comprises:
using a physical-to-logical (P2L) table to determine if the TU of the one or more TUs in the source block is a valid TU of the one or more valid TUs in the source block.

14. The method of claim 8, wherein the memory device comprises a NAND flash memory device.

15. A non-transitory computer-readable storage medium comprising instructions that, when executed by a processing device, cause the processing device to perform operations comprising:
selecting, by a processing device, a source block of a memory device for performing a media management operation, wherein the source block comprises one or more translation units (TUs), and wherein a TU comprises a respective set of memory cells;
identifying one or more valid TUs in the source block, wherein each valid TU of the one or more valid TUs corresponds to a respective set of memory cells comprising valid data;
grouping the one or more valid TUs identified in the source block into one or more candidate groups; and
performing the media management operation by: executing one or more read operations to retrieve the valid data from the one or more candidate groups of TUs, and writing the valid data into one or more destination blocks.

16. The non-transitory computer-readable storage medium of claim 15, wherein grouping the one or more valid TUs identified on the source block into one or more candidate groups further comprises:
enqueuing the one or more candidate groups into a read iteration queue, from which the one or more read operations on the one or more candidate groups of TUs are executed.

17. The non-transitory computer-readable storage medium of claim 15, wherein grouping the one or more valid TUs identified on the source block into one or more candidate groups further comprises:
identifying one or more multi-plane read candidates, wherein each of the one or more multi-plane read candidates is a valid TU of the one or more valid TUs identified on the source block, each of the one or more multi-plane read candidates corresponding to a respective multi-plane wordline, wherein all the one or more TUs are valid TUs; and
populating a multi-plane read candidate group with the one or more multi-plane read candidates, each of the one or more multi-plane read candidates corresponding to the respective multi-plane wordline.

18. The non-transitory computer-readable storage medium of claim 15, wherein grouping the one or more valid TUs identified on the source block into one or more candidate groups further comprises:
identifying one or more independent wordline (IWL) read candidates, wherein each of the one or more IWL read candidates is a valid TU of the one or more valid TUs identified on the source block, each corresponding to a multi-plane wordline, wherein at least one TU corresponding to the multi-plane wordline is an invalid TU, and wherein an invalid TU is a TU corresponding to a set of memory cells comprising invalid data; and
populating an IWL read candidate group with an IWL read candidate, of the one or more IWL read candidates, corresponding to each plane in a die.

19. The non-transitory computer-readable storage medium of claim 15, wherein selecting the source block for performing the media management operation is performed responsive to the source block meeting a threshold criterion, and wherein the threshold criterion comprises a threshold number of valid data items in the source block.

20. The non-transitory computer-readable storage medium of claim 15, wherein identifying the one or more valid TUs in the source block further comprises:
using a physical-to-logical (P2L) table to determine if the TU of the one or more TUs in the source block is a valid TU of the one or more valid TUs in the source block.
